(19) United States
(12) Patent Application Publication
(10) Pub. No.: US 2016/0323160 A1
(43) Pub. Date: Nov. 3, 2016

(54) DETECTION OF NODE.JS MEMORY LEAKS

(71) Applicant: AppDynamics, Inc., San Francisco, CA (US)

(72) Inventors: Dmitri Melikyan, Munich (DE); David Roth, San Francisco, CA (US)

(21) Appl. No.: 14/699,284

(22) Filed: Apr. 29, 2015

(51) Int. Cl. H04L 12/26; G06F 3/06

(52) U.S. Cl. CPC H04L 43/08; H04L 43/04; G06F 3/0604; G06F 3/0653; G06F 3/0652; G06F 3/0631; G06F 3/067

(57) ABSTRACT

A system detects memory leaks in Node.JS applications. The memory leaks are associated with lines of code rather than particular objects. Lines of code associated with a memory leak is identified by object allocation tracking. Object allocation for lines of code is tracked. A heap snapshot may be captured at the same time at which the object allocation occurs. The results of the object allocation are processed, including removal of objects cleaned up by garbage collection. Objects remaining in the object allocation results are then searched for the end heap snapshot. For objects found in the heap snapshot, the corresponding lines of code that generate the objects are reported to administrators the application.

### BACKGROUND OF THE INVENTION

The World Wide Web has expanded to provide web services faster to consumers. Web services may be provided by a web application which uses one or more services to handle a transaction. The applications may be distributed over several machines, making the topology of the machines that provides the service more difficult to track and monitor.

One platform on which business services are provided over a network is Node.JS. Node.JS is a software platform for scalable server side and networking applications. Node.JS applications are written in Java script, and can be run with the Node.JS runtime on Windows, a Macintosh operating system, and Linux with no changes. Node.JS applications maximize throughput and efficiency using non-blocking input output interfaces and asynchronous events and run on single threaded processes.

Unlike Java, Node.JS may process workflows using a single thread. Therefore, Node.JS applications cannot be monitored at the level of typical Java applications, which a processor may associate with different threads. In particular, it is difficult to analyze a Node.JS application for memory leaks. This is at least partially due to the fact that Node.JS is not an object oriented framework. What is needed is a way to identify memory leaks and Node.JS processes.

### SUMMARY OF THE CLAIMED INVENTION

The present technology detects memory leaks in Node.JS applications. The memory leaks are associated with lines of code rather than particular objects. Lines of code associated with a memory leak is identified by object allocation tracking. Object allocation for lines of code is tracked. A heap snapshot may be captured at the same time at which the object allocation occurs. The results of the object allocation tracking are processed, including removal of objects cleaned up by garbage collection. Objects remaining in the object allocation tracking results are then searched for the end heap snapshot. For objects found in the heap snapshot, the corresponding lines of code that generate the objects are reported to administrators the application.

An embodiment may include a method for tracking allocations. The method may track object allocations for a process executing on a server and communicating over a network with a remote computing device. A heap snapshot may be collected for the executing process on the server. An agent executing on the server may identify one or more objects that are tracked within the object allocation and contained in the heap snapshot. The agent may report the identified objects to a remote computing device.

An embodiment may include a system for monitoring a business transaction. The system may include a processor, a memory and one or more modules stored in memory and executable by the processor. When executed, the one or more modules may track object allocation for a process executing on a server and communicating over a network with a remote computing device, collect a heap snapshot for the executing process on the server, identify by an agent executing on the server one or more objects that are tracked within the object allocation and contained in the heap snapshot, and report by the agent the identified objects to a remote computing device

### BRIEF DESCRIPTION OF THE DRAWINGS

FIG. 1 illustrates a system for detecting memory leaks in a Node.JS system.

FIG. 2 illustrates a block diagram of a server executing a Node.JS application.

FIG. 3 illustrates a logical view of a node process.

FIG. 4 illustrates a method for reporting leak information or a Node.JS application.

FIG. 5 illustrates a method for tracking object allocation for a process.

FIG. 6 illustrates a method for identifying objects.

FIG. 7 illustrates a block diagram of a computing environment for implementing the present technology.

### DETAILED DESCRIPTION

The present technology detects memory leaks in Node.JS applications. The memory leaks are associated with lines of code rather than particular objects. Lines of code associated with a memory leak is identified by object allocation tracking. Object allocation for lines of code is tracked. A heap snapshot may be captured for the time at which the object allocation occurs. The results of the object allocation tracking are processed, including removal of objects cleaned up by garbage collection. Objects remaining in the object allocation tracking results are then searched for the end heap snapshot. For objects found in the heap snapshot, the corresponding lines of code that generate the objects are reported to administrators the application.

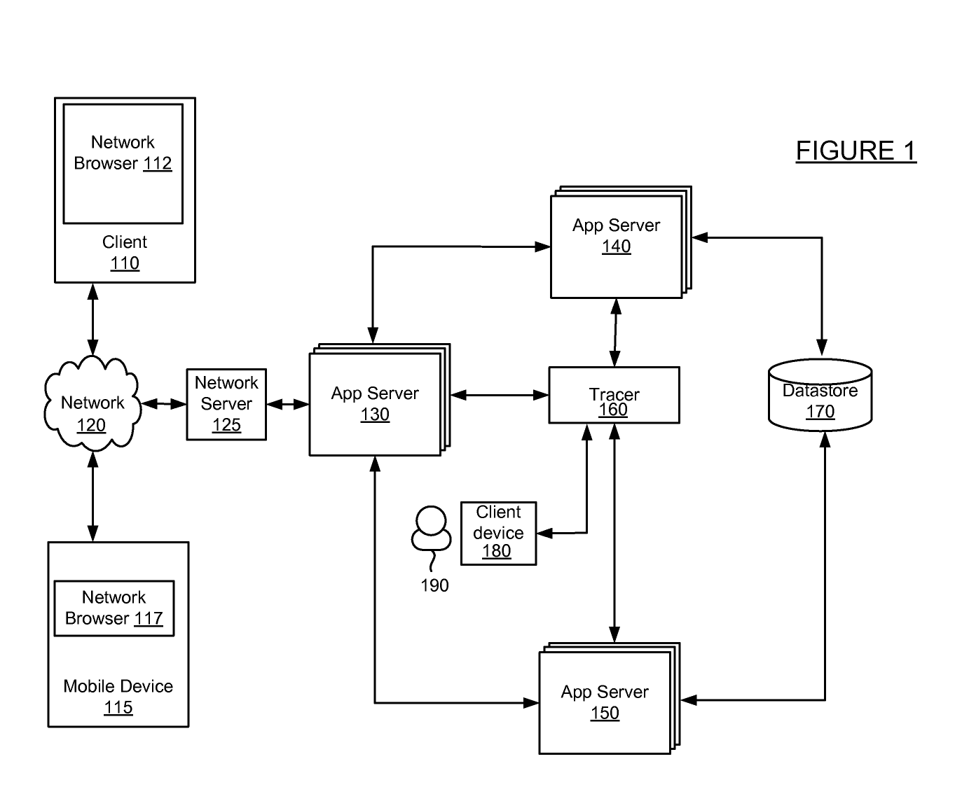

FIG. 1 illustrates a block diagram of a system for detecting memory leaks in a Node.JS application. The system of FIG. 1 may include client 110, mobile device 115, network 120, network server 125, application servers 130, 140 and 150, tracer 160, database 170, and client device 180.

Client 110 may include any device through which a user may initiate a request over network 120 to servers 130-140. Client device 110 may include network browser 110 and be implemented as a computing device, such as for example a laptop, desktop, workstation, or some other computing device. Network browser 112 may be a client application for sending requests and queries to an application server such as application server 130, as well as viewing content provided by an application server. Client device 110 may include hardware and/or software configured to access a web service provided by network server 125.

Mobile device 115 may be implemented as a portable device, such as for example a mobile phone, smart phone, tablet computer or other portable device. Mobile device 115 may include network browser 117, which may include a client application for viewing content provided by an application server, such as application server 130 via network server 125 over network 120

Network 120 may be used to receive and process communications, including requests and responses, between client 110, mobile device 115 and network server 125. In some embodiments, network 120 may also exist between other machines of FIG. 1, such as for example between application servers 130, 140 and 150, between application servers and data store 170, as well as other machines. Network 120 may include any public or private network for communicating data, such as for example a local area network, a wide area network, the internet, an intranet, a wireless network, a cellular network, or a combination of these networks.

Network server 125 may receive and process requests received from client 110 and mobile device 115 over network 120. Network server 125 may be implemented by the same machine or a different machine as application server 130. In some embodiments, a network server 125 may be an actual device or a logical device that processes requests and forwards requests or generates new requests to application server 130 to be serviced and returned to client 110 or mobile device 115.

Application server 130 may communicate with network server 125, application servers 140 and 150, datastore 170, and may include one or more applications 142. Application server 140 may be implemented on the same machine or a different machine as network server 130.

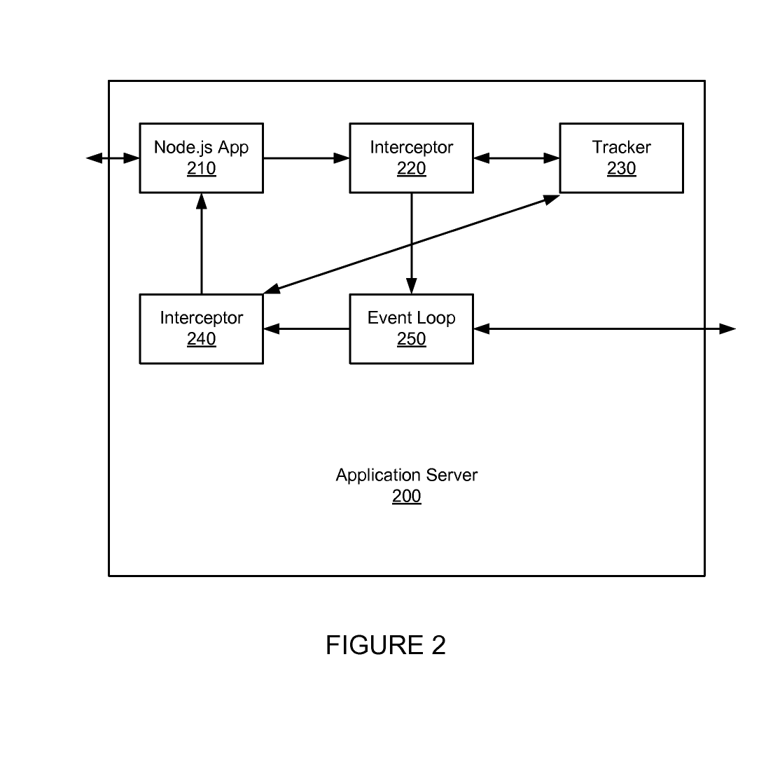

Application server 130 may include one or more Node.JS applications. The Node.JS application may be written in Java script and run on a Windows, Apple operating system (OS), or a Linux OS. Application server 130 may also include monitoring components which identify application functions and trace application functions which execute as part of the execution flow in the Node.JS platform. More detail for application server 130 is discussed below with respect to the block diagram of FIG. 2.

Application servers 140 and 150 may communicate with each other, application server 130, data store 170, network server 125, and tracer 160. Each of application servers 140 and 150 may include one or more Node.JS applications and monitoring components similar to application server 130. Application servers 130-150 may process distributed business transactions that involve Node.JS applications on one or more of servers 130-150.

Tracer 160 may be used to trace application functions of Node.JS applications. Tracer application 160 may receive information from monitoring components installed on an application of application server 130, 140 and 150. Tracer 160 may receive event information and transaction identifiers from application monitoring components, stitch the information and transaction identifiers together to determine virtual threads and runtime data for each virtual thread (contextual information), and report that data to a user. The data may be reported in any of several typical reporting methods, including alerts, email messages, SMS messages, and via a web-based interface viewable by client device 180.

Data store 170 may receive requests from application servers 130-150, process the request, and transmit a response to the requesting server.

FIG. 2 illustrates a Node.JS application within application server 200. The application server of FIG. 2 provides additional detail for each of application servers 130-150 of FIG. 1. Application server 200 includes Node.JS application 210, interceptor 220, tracker 230, interceptor 240, and event loop 240. Node.JS application 210 on application server 200 may receive a request from an external source, such as a remote computing device. As part of the request, application 210 will eventually send a message to event loop 250 for the request to be processed. Event loop 250 may process the request and optionally make additional requests, such as for example to database 170.

Interceptor 220 is positioned between application 210 and event loop 250 to intercept execution flow occurring between the Node.JS application 210 and the event loop 250. Interceptor 220 may intercept execution flow such as callback registrations, callback calls, and other execution flow. When intercepting execution flow, interceptor 220 may query tracker 230 to determine if a particular execution flow message is currently associated with a transaction ID. For example, if interceptor 220 intercepts a callback registration, interceptor 220 may determine from tracker 230 that no transaction ID is be associated with the callback registration, will create a transaction ID, and send the transaction ID to tracker 230. If a callback call is intercepted by 220, interceptor 220 will confirm that the callback is associated with a transaction ID and indicate to tracker 230 that a call for the transaction ID associated with that callback has been received.

After intercepting execution flow from application 210, interceptor 220 will forward the execution flow to event loop 250. Event loop 250 transmits requests based on the execution flow to outside services, such as database 170. Once the external request has been processed by a component outside the application server, a response will be received from the component by event loop 250.

When the callback processing is done, for example after receiving a message from database 170, event loop 250 will inform Node.JS application 210 that the callback has completed. Interceptor 240 may intercept information sent from event loop 250 to Node.JS application 210. Upon receiving a notification that the callback is complete, interceptor 240 will inform tracker 230 that the callback is complete. Upon receiving this information, tracker 230 will change the current contextual state to a different state. For example, upon receiving the callback registration notice, tracker 230 may set a contextual state to be switched upon receiving the callback call. Upon receiving the callback call, interceptor 200 informs tracker 230 and 230 actively sets the contextual state to a particular value associated with the call. This contextual state may be considered the “virtual thread” value. The contextual state is then switched to the next virtual thread value, a previous virtual thread value, or a value of null after the callback has completed.

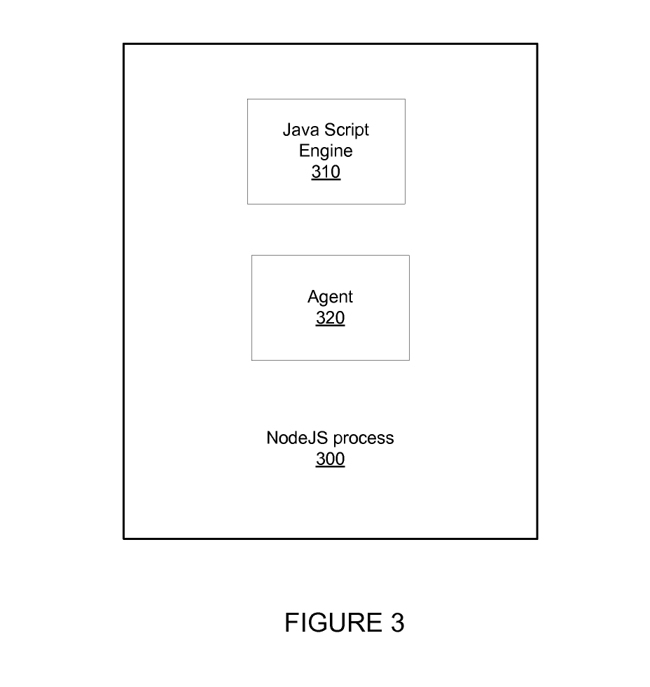

FIG. 3 illustrates a logical view of a Node.JS process. Node.JS process 300 may include JavaScript engine 310 an agent 320 executing within the process. JavaScript engine 310 may be implemented as server software for communicating with engine code in a network browser application. The engine 310 provides an application program interface (API) to collect a heap snapshot and allows for tracking of object allocation for a server application. The server application may provide content to be loaded and displayed in a web browser. The JavaScript engine may be implemented, for example, by V8 JavaScript engine, provided by Google, Inc.

Agent 320 may be installed on server 200 and execute to communicate with JavaScript engine 310, monitor a node application, and communicate with one or more remote machines. Agent 320 may collect monitoring information, aggregate the monitoring information, and send the aggregated information and other data to the remote machine.

The Node.JS process 300 may be created by executing the Node.JS application 210 of FIG. 2. The JavaScript engine 310 may execute within the process an agent 300 may communicate with the engine with the process.

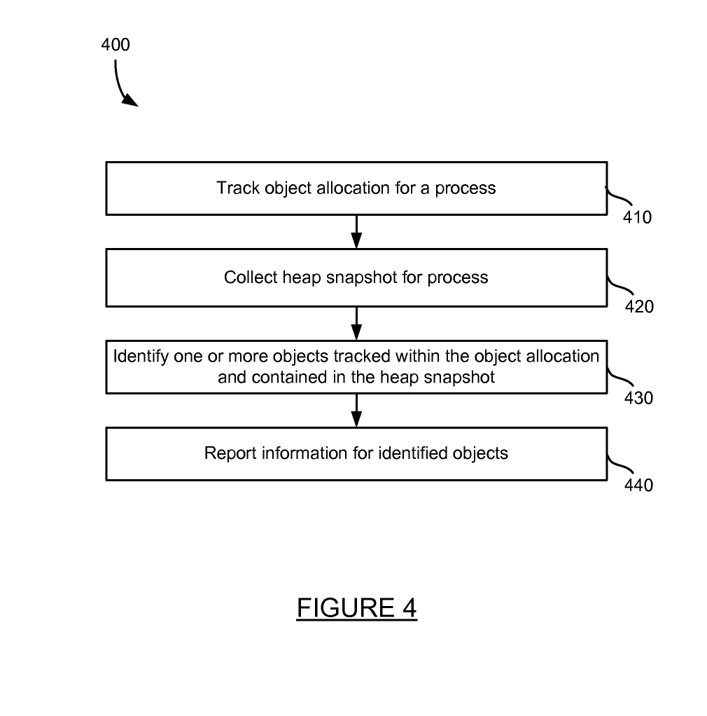

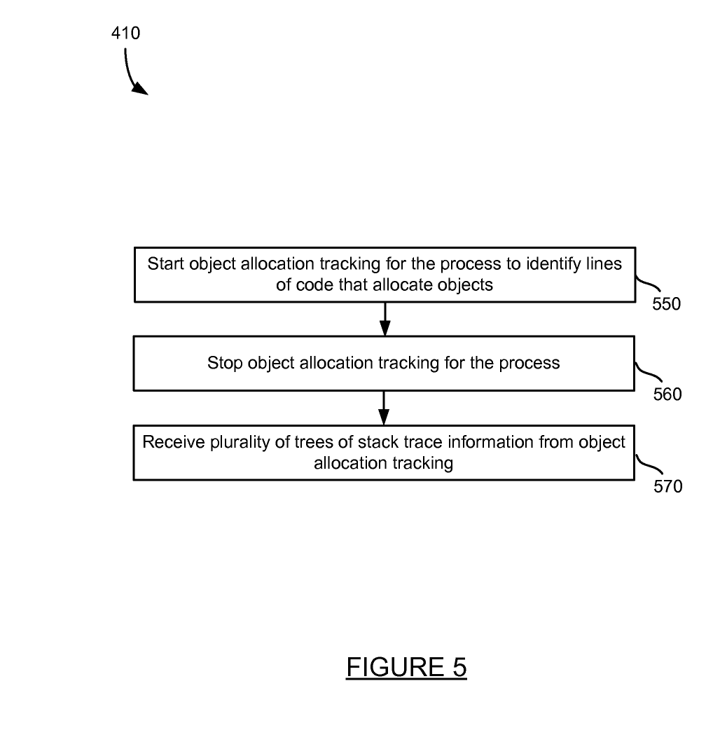

FIG. 4 illustrates a method for reporting leak information for a Node.JS application. First, object allocation may be tracked for a process at step 410. The object allocation tracking may be performed by an agent through the JavaScript engine API. More details for tracking object allocation are discussed with respect to the method of FIG. 5. A heap snapshot may be collected for the process at step 420. Capturing the heap snapshot may be performed by the agent via the JavaScript engine API as well. For example, the agent may send messages or instructions to the JavaScript engine API to collect the heap snapshot at the appropriate time.

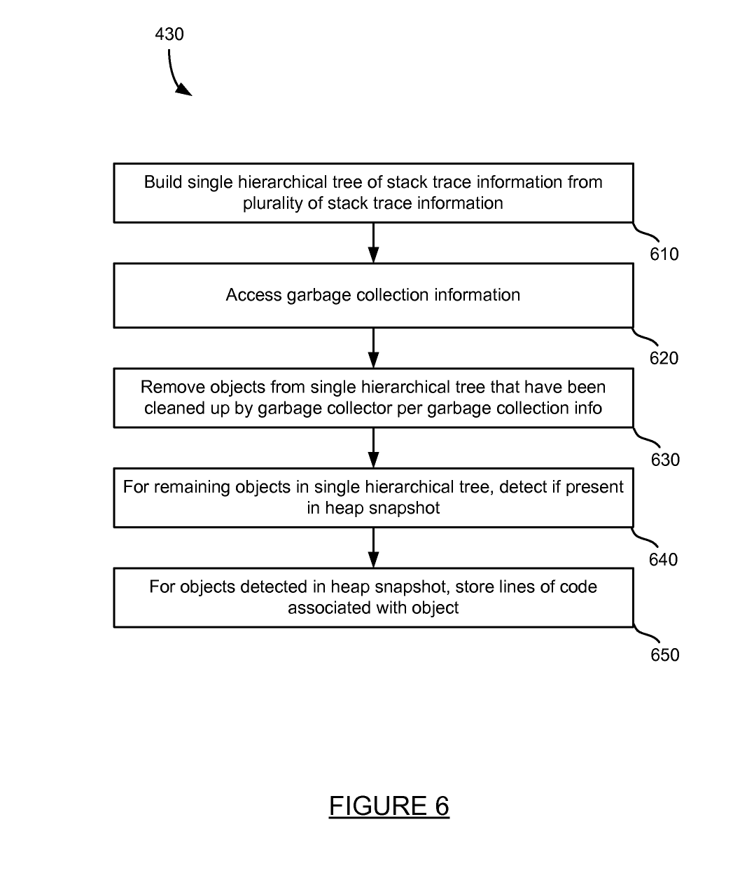

The agent may identify one or more objects tracked within the object allocation and contained in the heap snapshot at step 430. The retrieved data may be processed and cross checked, and the results are then stored. More details for identifying the one or more objects tracked within object allocation and contained within the heap snapshot is discussed with respect to the method of FIG. 6. The leak information is then reported for the identified objects at step 440. The leak information may be determined and reported in terms of lines of code that generate objects that are not closed via garbage collection. These un-closed objects are determined to be memory leaks.

FIG. 5 illustrates a method for tracking object allocation for a process. The method of FIG. 5 provides more detail for step 410 the method of FIG. 4. Object allocation tracking may begin with identifying lines of code that allocate objects at step 550. After a while, the object allocation tracking process ends at step 560. As a result of the object allocation tracking, a plurality of trees of stack trace information may be received from the object allocation tracking at step 570.

FIG. 6 illustrates a method for identifying objects. The method of FIG. 6 provides more detail for step 430 of the method of FIG. 4. First, a single hierarchical tree of stack trace information may be built from the plurality of stack trace trees at step 610. The plurality of trees may be combined into a single tree as part of the processing of the stack trace information. Garbage collection information may then be determined or accessed at step 620. In some instances, information may be retrieved by the agent from an API associated with the framework handling the process. In some instances, garbage collection information may be determined by objects determined to not be in the heap snapshot (i.e., objects not present are determined to be garbage collected)

Objects from the single hierarchical tree that have been cleaned up by a garbage collector may be removed at step 630. Removal of these objects is to eliminate them as potential memory leaks. They are likely not memory leaks because they have been cleaned up and are no longer consuming memory. For the remaining objects in the hierarchical tree, the agent determines if those objects are present in the heap snapshot at step 640. Each object is associated with an object ID that is assigned to it by the framework. For each object that remains in the single hierarchical tree, the object ID for those objects are searched for in the heap snapshot. For those objects detected in heap snapshot, the lines of code associated with those objects are retrieved from the heap snap shot and stored at step 650. These lines of code are determined to be associated with leaks because objects have not been cleaned out by a garbage collection process.

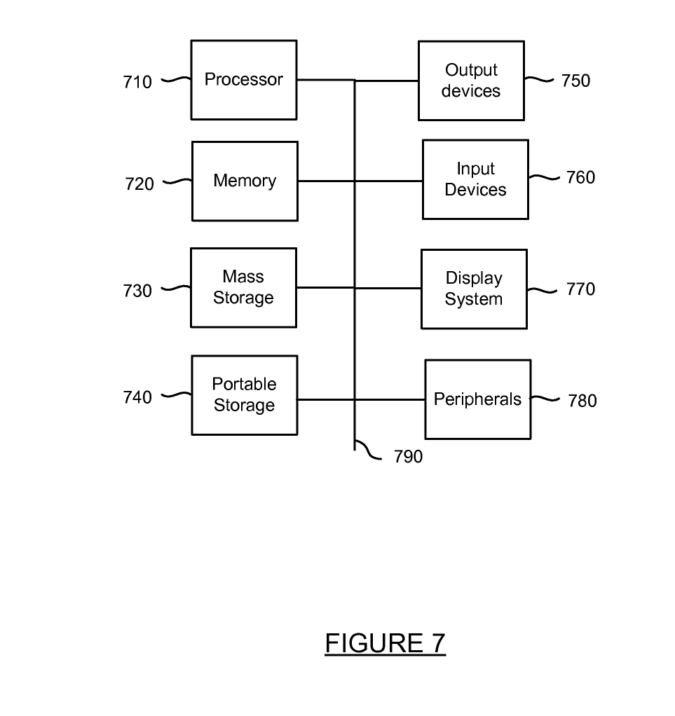

FIG. 7 is a block diagram of a computer system for implementing the present technology. System 700 of FIG. 7 may be implemented in the contexts of the likes of client 110, network server 125, application servers 130, 140 and 150, tracer 160, data store 170, and client device 180. A system similar to that in FIG. 7 may be used to implement a mobile device able to communicate wirelessly, such as a smart phone or tablet computer, but may include additional components such as an antennas and radios, additional microphones, and other components typically found in mobile devices such as a smart phone or tablet computer.

The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for tracking allocations, comprising:
tracking object allocation for a process executing on a server and communicating over a network with a remote computing device;
collecting a heap snapshot for the executing process on the server;
identifying by an agent executing on the server one or more objects that are tracked within the object allocation and contained in the heap snapshot; and
reporting by the agent the identified objects to a remote computing device.

2. The method of claim 1, further comprising processing stack trace information received from the object allocation tracking to remove data associated with a subset of the tracked objects.

3. The method of claim 2, wherein the removed data is associated with objects that have been garbage collected.

4. The method of claim 1, wherein the identifying includes:
detecting object identifiers in the stack trace information associated with objects that have not been garbage collected; and
determining if the detected object identifiers are located within the heap snapshot.

5. The method of claim 1, wherein tracking object allocation includes:
starting object allocation tracking for the process by the agent to identify lines of code that allocate objects; and
ending the object allocation tracking for the process by the agent, the agent starting and stopping the process by issuing messages to an application program interface associated with an engine that performs the tracking.

6. The method of claim 1, wherein the object allocation tracking results in a plurality of trees of stack trace information;

7. The method of claim 6, wherein identifying includes building a single hierarchical structure from the plurality of trees of stack trace information.

8. The method of claim 1, wherein identifying includes identifying one or more lines of code associated with the identified objects.

9. A non-transitory computer readable storage medium having embodied thereon a program, the program being executable by a processor to perform a method for tracking allocations, the method comprising:
tracking object allocation for a process executing on a server and communicating over a network with a remote computing device;
collecting a heap snapshot for the executing process on the server;
identifying by an agent executing on the server one or more objects that are tracked within the object allocation and contained in the heap snapshot; and
reporting by the agent the identified objects to a remote computing device.

10. The non-transitory computer readable storage medium of claim 9, the method further comprising processing stack trace information received from the object allocation tracking to remove data associated with a subset of the tracked objects.

11. The non-transitory computer readable storage medium of claim 10, wherein the removed data is associated with objects that have been garbage collected.

12. The non-transitory computer readable storage medium of claim 9, wherein the identifying includes:
detecting object identifiers in the stack trace information associated with objects that have not been garbage collected; and
determining if the detected object identifiers are located within the heap snapshot.

13. The non-transitory computer readable storage medium of claim 9, wherein tracking object allocation includes:
starting object allocation tracking for the process by the agent to identify lines of code that allocate objects; and
ending the object allocation tracking for the process by the agent, the agent starting and stopping the process by issuing messages to an application program interface associated with an engine that performs the tracking.

14. The non-transitory computer readable storage medium of claim 9, wherein the object allocation tracking results in a plurality of trees of stack trace information;

15. The non-transitory computer readable storage medium of claim 14, wherein identifying includes building a single hierarchical structure from the plurality of trees of stack trace information.

16. The non-transitory computer readable storage medium of claim 1, wherein identifying includes identifying one or more lines of code associated with the identified objects.

17. A system for tracking allocations, comprising:
an application server including one or more processors and memory; and
one or more modules stored in memory and executable by at least one of the one or more processors to track object allocation for a process executing on a server and communicating over a network with a remote computing device, collect a heap snapshot for the executing process on the server, identify by an agent executing on the server one or more objects that are tracked within the object allocation and contained in the heap snapshot, and report by the agent the identified objects to a remote computing device.

18. The system of claim 17, the one or more modules further executable to process stack trace information received from the object allocation tracking to remove data associated with a subset of the tracked objects.

19. The system of claim 18, wherein the removed data is associated with objects that have been garbage collected.

20. The system of claim 17, wherein the identifying includes detecting object identifiers in the stack trace information associated with objects that have not been garbage collected and determining if the detected object identifiers are located within the heap snapshot.

21. The system of claim 17, wherein tracking object allocation includes starting object allocation tracking for the process by the agent to identify lines of code that allocate objects and ending the object allocation tracking for the process by the agent, the agent starting and stopping the process by issuing messages to an application program interface associated with an engine that performs the tracking.

22. The system of claim 17, wherein the object allocation tracking results in a plurality of trees of stack trace information;

23. The system of claim 22, wherein identifying includes building a single hierarchical structure from the plurality of trees of stack trace information.

24. The system of claim 17, wherein identifying includes identifying one or more lines of code associated with the identified objects.
